(19) United States
(12) Patent Application Publication
(10) Pub. No.: US 2009/0122524 A1
(43) Pub. Date: May 14, 2009

(54) AQUA-LAMP-INCORPORATED BOTTLE STOPPER

(76) Inventor: CHIN-SHENG YANG, Tainan City (TW)

Correspondence Address: LEONG C LEI, PMB # 1008, 1867 YGNACIO VALLEY ROAD, WALNUT CREEK, CA, 94598, US

(21) Appl. No.: 12/241,099

(22) Filed: Sep. 30, 2008

(30) Foreign Application Priority Data
Nov. 12, 2007 (TW) 096219030

(51) Int. Cl. F21V 33/00

(52) U.S. Cl. 362/101

(57) ABSTRACT

An aqua-lamp-incorporated bottle stopper includes a light-transmitting aqua lamp portion to which a touch control module is coupled. The touch control module includes a micro-switch that is employed to selectively actuate a power source to drive the operation of an illuminator for giving off light. Also coupled to the touch control module is a connection base that is a hollow structure forming an interior chamber that receives the touch control module therein and coupled to the light-transmitting aqua lamp portion. An opposite end of the connection base forms a fitting portion for fitting into a mouth of a bottle. As such, when a touch is applied to the bottle stopper, the micro-switch is shaken and actuated to have the touch control module activating the illuminator to give off light traveling to and through the light-transmitting aqua lamp portion for providing a decorative effect.

### TECHNICAL FIELD OF THE INVENTION

The present invention generally relates to an aqua-lamp-incorporated bottle stopper, and particularly to a decoration that employs a structure that can be fit to a mouth of a bottle and that can be activated to conduct on a power source upon subjected to slight touch so as to provide dual effects of light emission and decoration of aqua lamp.

### DESCRIPTION OF THE PRIOR ART

Bottles containing therein any desired contents are commonly used in daily living. One example is a wine bottle. For those interested in collecting and tasting excellent and valuable wines, to preserve wine in a bottle, a cork or stopper to close the bottle mouth is a must in order to retain the original taste of wine. It is often difficult to acquire a stopper having a good shape matching the wine bottle for it requires not only a noble feeling but also match with the bottle and wine. For example, the wine or bottle contains substance produced in a special season or a special occasion can be used in the design of the bottle stopper. Thus, various designs of bottle stopper are available and provide a key effect for the overall design of bottle. Apparently, there is a large space available for new designs of bottle stopper.

In view of this, based on years' experience in development and manufacturing of decorations and arrangement of decorations, the present applicant wishes to provide a bottle stopper that, besides the original function of closing a bottle mouth, provides an additional lighting effect and that can be made to mate other decorations thereon or of the bottle. With successive attempts in the development of the stopper, an aqua-lamp-incorporated bottle stopper is invented in accordance with the present invention.

### SUMMARY OF THE INVENTION

Thus, the present invention provides an aqua-lamp-incorporated bottle stopper, which generally comprises a light-transmitting aqua lamp portion to which a touch control module is coupled. The touch control module comprises a micro-switch that is employed to selectively actuate a power source to drive the operation of an illuminator for giving off light. Also coupled to the touch control module is a connection base that is a hollow structure forming an interior chamber that receives the touch control module therein and coupled to the light-transmitting aqua lamp portion. An opposite end of the connection base forms a fitting portion for fitting into a mouth of a bottle. As such, when a touch is applied to the bottle stopper, the micro-switch is shaken and actuated to have the touch control module activating the illuminator to give off light traveling to and through the light-transmitting aqua lamp portion for providing a decorative effect.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an aqua-lamp-incorporated bottle stopper in accordance with the present invention.

FIG. 2 is a schematic view illustrating a touch control module of the aqua-lamp-incorporated bottle stopper of the present invention.

FIG. 3 is a cross-sectional view of the aqua-lamp-incorporated bottle stopper of the present invention in an assembled form.

FIG. 4 is a cross-sectional view illustrating an application of the aqua-lamp-incorporated bottle stopper of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

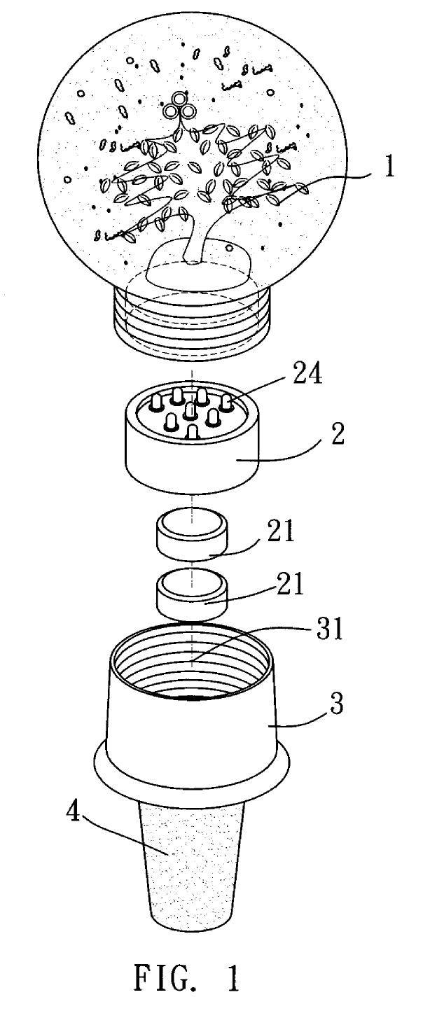

With initial reference to FIG. 1, which illustrates an exploded view of an aqua-lamp-incorporated bottle stopper constructed in accordance with the present invention, the aqua-lamp-incorporated bottle stopper of the present invention comprises a light-transmitting aqua lamp portion 1, a touch control module 2, a connection base 3, and a fitting portion 4.

The light-transmitting aqua lamp portion 1 has a three-dimensional light-transmittable configuration in the outside appearance and is filled with a flowable liquid in the interior thereof. If desired, the flowable liquid may be mixed with flake- or particle-like spangles and/or a shaped decoration, such as a Christmas tree, a Santa Claus figure, or a deer.

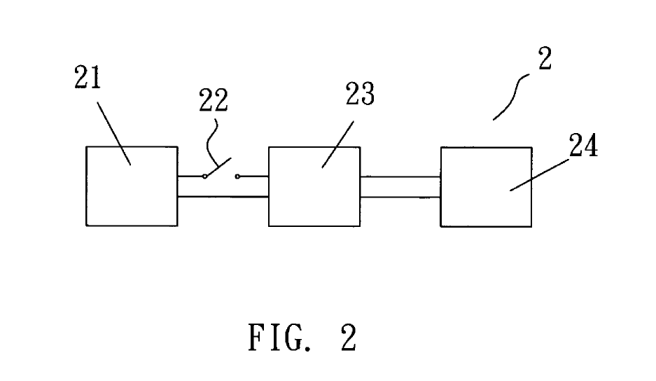

Also referring to FIG. 2, the touch control module 2 comprises a structure that embeds and retains therein a power source 21, a micro-switch 22, a control unit 23, and at least one illuminator 24, and is fit and received inside the light-transmitting aqua lamp portion 1. To reduce the overall size, the power source 2 can comprise for example one or more mercury cells. The micro-switch 22 functions to detect slight vibration caused by external activity so as to get conducted on and an example is a mercury switch. The control unit 23 is designed for intermittent or selective activation. The illuminator 24 can be any light generation device or element, such as a light-emitting diode, which is arranged in a direction facing the light-transmitting aqua lamp portion 1.

The connection base 3 comprises a hollow structure forming an interior chamber 31, which receives the touch control module 2 therein.

The fitting portion 4 is coupled to, preferably formed in an integral manner with, an opposite end of the connection base 3 and has an overall tapered configuration corresponding to a mouth 51 of a bottle 5. The fitting portion 4 can be made of for example flexible or soft plastics.

As such, when the mouth 51 of the bottle 5 is touched, the slight vibration induced on the bottle cause activation of the micro-switch 22, which then turns on the touch control module 2 to activate the illuminator 24. The illuminator 24 thus generates and gives off light, which is transmitted to the light-transmitting aqua lamp portion 1 to provide a decorative effect.

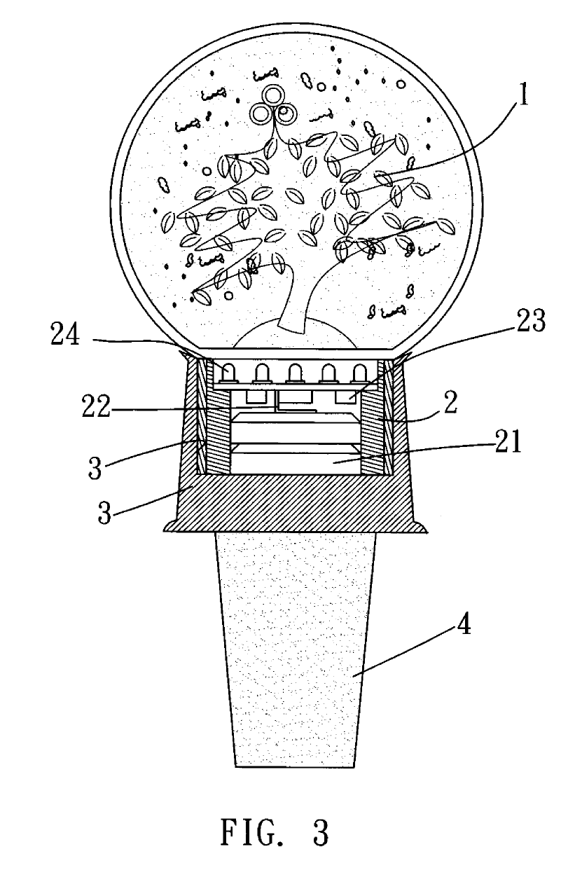

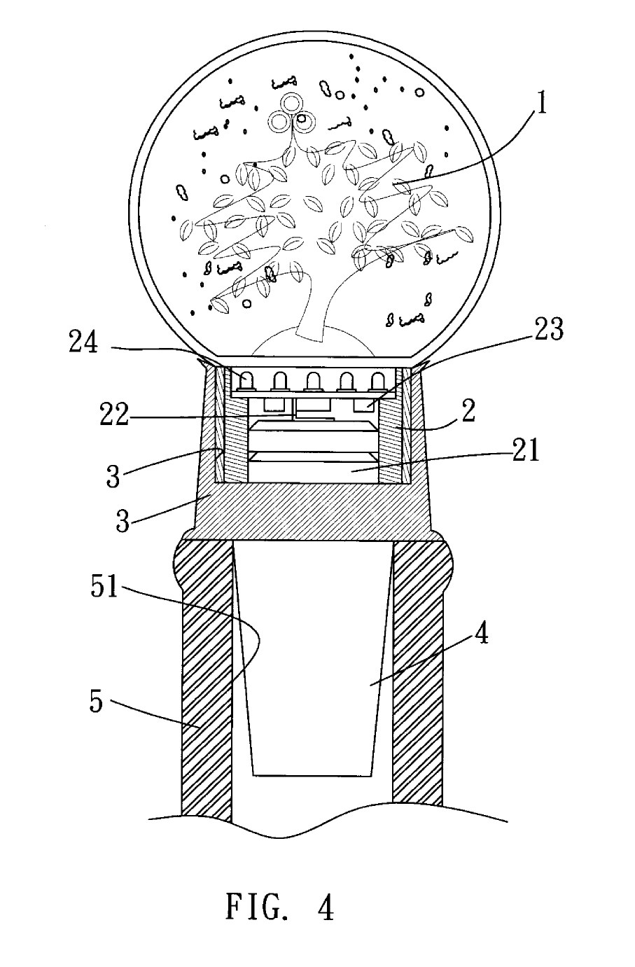

Further referring to FIGS. 3 and 4, to assemble, the light source 21, the micro-switch 22, the control unit 23, and the illuminator 24 are first fit into the touch control module 2 and the so assembled touch control module 2 is then fit and set in the light-transmitting aqua lamp portion 1, which contains therein a liquid of low flowability, in such a way that the illuminator 24 is directed toward the light-transmitting aqua lamp portion 1. The connection base 3 is then coupled to an end portion of the touch control module 2 in such a way that the connection base 3 encloses the touch control module 2 and lies against an outer surface of the light-transmitting aqua lamp portion 1. The fitting portion 4 that is coupled to or integrally formed with the opposite end of the connection base 3 is made of a soft plastic material or other soft material, such as cork or rubber and is configured and sized to fit into a mouth 51 of a bottle 5.

With the fitting portion 4 properly fit into and coupled to the mouth 51 of the bottle 5, when a user contacts or touches the light-transmitting aqua lamp portion 1 of the aqua-lamp-incorporated bottle stopper in accordance with the present invention, a little force applied to the stopper or the bottle is sufficient to cause the operation of the micro-switch 22 of the touch control module 2 to activate the control unit 23 and the illuminator 24, which may lead to for example an intermittent activation of a predetermined time period, such as few seconds, so that light is given off from the illuminator 24 and travels to and through the light-transmitting aqua lamp portion 1 to generate a light dazzling/flashing effect. The lighting effect of the illuminator 24 can be completely shut down after the lapse of the time period, such as few seconds, and can be re-activated by another touch by the user to make the illuminator 24 giving off light again to add the dazzling/flashing effect.

From the above description of the constituent parts and operation of the aqua-lamp-incorporated bottle stopper in accordance with the present invention, several advantages can be recognized and will be briefed as follows:

(1) The bottle stopper of the present invention uses a touch control module that incorporates a micro-switch so that a slight action applied to the bottle or the stopper is sufficient to activate an illuminator to give off light. Thus, the design of the bottle stopper can be made versatile and decoration can also be realized with the stopper of the present invention.

(2) The bottle stopper of the present invention uses a light-transmitting aqua lamp portion that has a three-dimensional configuration and contains therein a flowable liquid mixed with flake- or particle-like spangles and/or a shaped decoration to enhance the beautifulness and serve as a decoration.

To conclude, the above description of the integral formation of the structure in accordance with the embodiment of the present invention reveals that the present invention does perfectly exhibit the decorative characteristics of an aqua lamp and that the present invention provides an effect of dazzling/flashing of light through the operation of the illuminator by means of the activation of the touch control module so that a more vivid and dynamic feeling is realized through the flowability of the liquid contained in the aqua lamp portion.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An aqua-lamp-incorporated bottle stopper, comprising a light-transmitting aqua lamp portion, a connection base, a touch control module, and a fitting portion, wherein:
the light-transmitting aqua lamp portion comprises a light-transmittable three-dimensional structure in which a flowable liquid is receivable;
the touch control module comprises a structure that contains therein a power source selectively actuated by a micro-switch to activate operation of an illuminator;
the connection base comprises a hollow structure forming an interior chamber which receives the touch control module therein and coupled to the light-transmitting aqua lamp portion; and
the fitting portion is formed on an opposite end of the connection base and is adapted to fit into a mouth of a bottle;
whereby when a vibration is caused by applying a touch to the light-transmitting aqua lamp portion, the micro-switch is caused to have the touch control module activating the illuminator so that the illuminator gives off light that is allowed to travel to and through the light-transmitting aqua lamp portion to provide a decorative effect.

2. The aqua-lamp-incorporated bottle stopper according to claim 1, wherein the light-transmitting aqua lamp portion contains therein a liquid of low flowability.

3. The aqua-lamp-incorporated bottle stopper according to claim 1, wherein a flowable liquid is received in the light-transmitting aqua lamp portion and contains flake-like spangles.

4. The aqua-lamp-incorporated bottle stopper according to claim 1, wherein a flowable liquid is received in the light-transmitting aqua lamp portion and contains particle-like spangles.

5. The aqua-lamp-incorporated bottle stopper according to claim 1, wherein a flowable liquid is received in the light-transmitting aqua lamp portion and contains therein shaped decorations.

6. The aqua-lamp-incorporated bottle stopper according to claim 1, wherein the fitting portion is made of a soft plastic material.

7. The aqua-lamp-incorporated bottle stopper according to claim 1, wherein the touch control module comprises a control unit that controls the operation of the illuminator.

8. The aqua-lamp-incorporated bottle stopper according to claim 1, wherein the illuminator of the touch control module comprises a light-emitting diode.

9. The aqua-lamp-incorporated bottle stopper according to claim 1, wherein the power source comprises a mercury cell.

10. The aqua-lamp-incorporated bottle stopper according to claim 7, wherein the control unit controls the illuminator in an intermittent activation manner.

11. The aqua-lamp-incorporated bottle stopper according to claim 7, wherein the control unit controls the illuminator in a selective activation manner.
